(19) United States
(12) Patent Application Publication
(10) Pub. No.: US 2010/0092620 A1
(43) Pub. Date: Apr. 15, 2010

(54) HIGH FIBER COMPOUND COATING FOR FOOD PRODUCTS

(76) Inventors: Edith Salinas Bravo, Battle Creek, MI (US); Richard Norris Flaget, Richland, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/577,862

(22) Filed: Oct. 13, 2009

Related U.S. Application Data
(60) Provisional application No. 61/104,865, filed on Oct. 13, 2008.

(51) Int. Cl. A23L 1/308; A23L 1/09; A23L 1/10; A23L 1/164; A23L 1/22; A23P 1/02; A23P 1/08

(52) U.S. Cl. 426/93; 426/615; 426/618; 426/634; 426/629; 426/452; 426/96; 426/289; 426/294; 426/295

(57) ABSTRACT

A compound coating has a very high level of dietary fiber from about 35% to about 75% by weight, and a particle size of about 35 microns or less. The compound coating is formed by mixing a fat portion and the dietary fiber, and then micro-grinding the compound coating to the fine particle size. The compound coating can include soluble fiber, insoluble fiber, or combinations thereof, such as polydextrose and short chain fructo-oligosaccharides. The compound coating can be applied to a wide variety of food forms including wafers, cereals, crackers, and other foods. The compound coating can be applied by spraying the coating onto the food form or pumping the coating through depositing spindles and onto the food form.

### RELATED APPLICATIONS

This application claims the benefit of U.S. Provisional Application No. 61/104,865, filed Oct. 13, 2008.

### STATEMENT REGARDING FEDERALLY SPONSORED RESEARCH

None.

### TECHNICAL FIELD

This invention relates generally to high fiber food products and, more particularly, to high fiber compound coatings wherein the compound coating can be applied to or combined with a large variety of food products to provide a high level of fiber.

### BACKGROUND OF THE INVENTION

Health advocates have long promoted the need for consumers to increase their intake of dietary fiber, both soluble and insoluble. Often consumers are directed to increase their consumption of whole grains or foods that contain whole grains to increase fiber. Food manufactures have responded to this interest by offering more foods that have higher percentages of whole grains in them, however, use of whole grains is not always possible for all types of foods. Many foods do not lend themselves to inclusion of whole grains. As a result, food manufactures have also looked to other sources of fiber for inclusion in food products. The sources of fiber have included cereal brans, barley, psyllium, legumes, inulin, fructo-oligosaccharides (FOS), polydextrose, vegetable sources, fruit sources, nuts and flax seeds. These sources of fiber have been of some use, but they also present processing difficulties in food manufacture. As a result of the processing difficulties, the highest levels of fiber intermediate food materials that have previously been achieved are about 35% by weight. These high percentage fiber intermediate products are further processed to produce final food products having lower levels of fiber in them. In addition, this approach often requires that the manufacturing process for each food product be altered to produce a higher fiber version of the food product.

### SUMMARY OF THE INVENTION

This invention provides a compound coating having a very high level of dietary fiber of about 35% to about 75% by weight of the compound coating, and the compound coating has a particle size of about 35 microns or less. The dietary fiber of the compound coating can include soluble fiber, insoluble fiber, or a combination of both types of fiber. The fine particle size of the compound coating provides improved mouthfeel and processability. The compound coating provides improved mouthfeel and processability, and has a rheology permitting use in typical coating spindles, waterfall systems, and bath systems.

The compound coating can be applied to a wide variety of food forms including cereals, granola, snack bars, snack foods, cookies, crackers, and other foods to provide a high fiber food product. In a specific example provided below, the compound coating is applied to wafer straws, but the invention is not so limited.

This invention also provides a process of forming the high fiber compound coating, including grinding components of the compound coating to a particle size of less than about 35 microns. The invention also provides a process of forming the high fiber food product with minimal disruption of existing food manufacturing processes.

These and other features and advantages of this invention will become more apparent to those skilled in the art from the detailed description of a preferred embodiment.

### DETAILED DESCRIPTION OF A PREFERRED EMBODIMENT

The present invention is directed toward a high dietary fiber compound coating material, a food product including the high fiber compound coating, and the processes of forming the same. The compound coating includes the dietary fiber in an amount of about 35% to about 75% by weight of the compound coating and a particle size of about 35 microns or less. In a specific example, the compound coating is applied to a rolled wafer straw-like product, however the compound coating can be applied to a wide variety of other foods.

The compound coating includes dietary fiber in an amount of about 35% to about 75% by weight, and more preferably from about 55% to about 65% by weight of the compound coating. Many sources of dietary fiber can be used in the present invention, including, but not limited to, polydextrose, short chain fructo-oligosaccharides (FOS), galacto-oligosaccharides (GOS), lignans, pectins, cereal brans, barley, psyllium, legumes, inulin, fructo-oligosaccharides, vegetable sources, fruit sources, nuts, and flax seeds. In the specific example below, the dietary fiber includes a combination of polydextrose and short chain fructo-oligosaccharides. There are many sources of polydextrose including the STA-LITE® III family of polydextrose from Tate & Lyle and the Litesse® Super Improved Polydextrose family from Danisco. The preferred short chain fructo-oligosaccharides are ones having a degree of polymerization of from 2 to 10 and more preferably from 3 to 5. A preferred source of short chain FOS is the product ACTILIGHT® available from Beghin-Say Company, France.

In addition to the dietary fiber, the compound coating includes various other ingredients. The compound coating is typically fat-based or includes a fat portion, such as cocoa butter or a cocoa butter equivalent of a blend of palm oil and shea nut oil, such as Choclin. The compound coating also typically includes sugar, surfactant or emulsifier, color, and flavor additives. The surfactant or emulsifier can include soy lecithin, preferably non-GMO soy lecithin. The flavor additives typically include citric acid, fruit powders, cocoa powder, and chocolate. However, the compound coating can be created in any flavor desired as known to those of ordinary skill in the art. The above-mentioned additional ingredients are only examples of ingredients that can be included in the compound coating along with the dietary fiber, and the compound coating can include fewer ingredients or other ingredients instead of or in addition to those listed.

The compound coating also includes a particle size of about 35 microns or less, and preferably about 30 microns or less. The fine particle size of the high fiber compound coating provides improved mouthfeel and processability. The compound coating also has rheology permitting use of the compound coating in typical coating spindles, waterfall systems, and bath systems.

The compound coating is typically formed by mixing the components of the compound coating in a mixer, and grinding or micro-grinding the compound coating to a particle size of about 35 microns or less, and preferably about 30 microns or less. The process of forming the compound coating can alternatively include grinding each of the components of the compound coating to a particle size of about 35 microns or less, and then mixing the components together in the mixer. The process can also include agitating the components in the mixer and aeration.

The process of forming the compound coating typically occurs in a mixer, grinder, or dual purpose centrifugal batch refiner/conche, such as a McIntye Refiner/Conche machine. The mixing and the grinding of the compound coating typically occurs at a temperature of about 55 to about 65° Celsius. The process typically proceeds for about 12 hours, however shorter times are possible as long as the particle size is about 35 microns or less, and preferably about 30 microns or less. The process of forming the compound coating can include a continuous process, for example using a five roller system, as opposed to the batch process.

The compound coating can be applied to a food form to provide a high fiber food product. The food form typically includes ready-to-eat cereal, granola, snack bars, snack foods, cookies, crackers, or nuts, but can include other foods. The coating can be applied to the food form by spreading the coating onto the food form, spraying the coating onto the food form, rolling the food form in the coating, injecting the coating into the food form, pumping the coating through depositing spindles and onto the food form, and other methods.

In the following example, either a chocolate compound coating or a strawberry compound coating is produced as described below. The components of the chocolate compound coating and of the strawberry compound coating are shown in Table 1 in terms of percent by weight based on the total weight of the compound coating.

TABLE 1

| Component | Chocolate | Strawberry |
|---|---|---|
| Cocoa butter equivalent palm oil and | 28.00 | 28.00 |
| shea nut oil blend | | |
| Polydextrose | 49.00 | 49.00 |
| Soy lecithin | 0.40 | 0.40 |
| Polyglycerol polyricinoleate (PGPR) | 0.30 | 0.30 |
| Short chain FOS | 12.00 | 12.00 |
| Chocolate flavor | 0.60 | 0.00 |
| Dutched red cocoa powder | 9.00 | 0.00 |
| Granulated sugar | 0.70 | 8.75 |
| Citric acid anhydrous | 0.00 | 0.25 |
| Strawberry flavor | 0.00 | 0.40 |
| Freeze dried strawberry powder | 0.00 | 0.80 |
| Color | 0.00 | 0.10 |

The compound coatings are produced as follows. The fat portion of the compound coating, including the cocoa butter equivalent palm oil and shea oil blend and PGPR, are added to a dual purpose centrifugal batch refiner/conche followed by the dietary fibers and other non-fat components. The components of the compound coating are mixed together and ground until the compound coating achieves a particle size of about 35 microns or less, and preferably 30 microns or less. During the mixing and grinding process, the compound coating is kept at a temperature of about 55 to about 65° Celsius. The total mixing and grinding time is approximately 12 hours, however shorter times are possible as long as the particle size is about 35 microns or less.

In the present example, the high fiber compound coating is applied to snacking straws, also known as wafers. The wafers are formed by first creating a batter. The batter formulation for the wafer is given in Table 2, and the component amounts are given in wt % on a dry basis. The batter includes water in an amount of about 37.3% by weight of the batter.

TABLE 2

| Component | Percent by weight (dry basis) |
|---|---|
| Sugar | 23.404 |
| Short chain FOS | 9.0-11.0 |
| Polydextrose | 5.0-7.0 |
| Fructose | 3.191 |
| Skim milk powder | 2.128 |
| Soft wheat flour | 53.191 |
| Vegetable oil | 0.532 |
| Vanilla | 0.213 |
| Salt | 0.213 |
| Lecithin | 0.638 |
| Glucose | 1.596 |
| Dried whole eggs | 0.002 |
| Sesame flour | 0.001 |
| Water | 0 |

The wafer batter is cooked and the compound coating is applied to the cooked wafer to form a high fiber food product. The high fiber food product includes a ratio of about 65% by weight wafer to about 35% by weight compound coating. The compound coating is applied to the wafer by rolling the wafer in the compound coating or pumping the compound coating through depositing spindles and onto the wafer. The actual cooking temperatures and times are adjusted as known to those of ordinary skill in the art. The use of wafer roller machines being somewhat art and science.

The final shape of the food product is straw-like and lined with the compound coating. The amount of dietary fiber in the compound coating combined with the dietary fiber added to the wafer formulation allows a serving of three straws totaling 35 grams to provide 10 grams of dietary fiber, which is about 40% of the U.S. government-recommended daily allowance. This process enables what would be considered a snack to provide a significant amount of fiber in a single serving. As noted above, the process can be adapted for use with a wide variety of food forms to provide a wide variety of high fiber food products.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A high fiber compound coating comprising:
dietary fiber in an amount of about 35% to about 75% by weight of said compound coating; and
a particle size of the compound coating of about 35 microns or less.

2. A high fiber compound coating as set forth in claim 1 wherein said particle size is less than about 30 microns.

3. A high fiber compound coating as set forth in claim 1 wherein said dietary fiber includes at least one of polydextrose, short chain fructo-oligosaccharides, galacto-oligosaccharides, lignan, pectins, cereal brans, barley, psyllium, legumes, inulin, fructo-oligosaccharides, vegetable sources, fruit sources, nuts, fax seeds, and combinations thereof.

4. A high fiber compound coating as set forth in claim 3 wherein said dietary fiber includes a combination of said polydextrose and said short chain fructo-oligosaccharides.

5. A high fiber compound coating as set forth in claim 4 wherein said short chain fructo-oligosaccharides have a degree of polymerization of 2 to 10.

6. A high fiber compound coating as set forth in claim 1 including a fat portion.

7. A high fiber compound coating as set forth in claim 6 wherein said fat portion includes at least one of cocoa butter, a cocoa butter equivalent of a palm oil and shea nut oil blend, and polyglycerol polyricinoleate.

8. A high fiber compound coating as set forth in claim 1 including at least one of sugar, surfactant, emulsifier, color, and flavor additives.

9. A high fiber food product comprising:
a food product comprising a compound coating;
said compound coating including dietary fiber present in an amount of about 35% to about 75% by weight of said compound coating; and
said compound coating having a particle size of about 35 microns or less.

10. A high fiber food product as set forth in claim 9 wherein said particle size of said compound coating is less than about 30 microns.

11. A high fiber food product as set forth in claim 9 wherein said dietary fiber of said compound coating includes at least one of polydextrose, short chain fructo-oligosaccharides, galacto-oligosaccharides, lignan, pectins, cereal brans, barley, psyllium, legumes, inulin, fructo-oligosaccharides, vegetable sources, fruit sources, nuts, flax seeds, and combinations thereof.

12. A high fiber food product as set forth in claim 9 wherein said compound coating includes a fat portion.

13. A high fiber food product as set forth in claim 12 wherein said fat portion of said compound coating includes at least one of cocoa butter, a cocoa butter equivalent of a palm oil and shea nut oil blend, and polyglycerol polyricinoleate.

14. A high fiber food product as set forth in claim 9 wherein said compound coating includes at least one of sugar, surfactant, emulsifier, color, and flavor additives.

15. A high fiber food product as set forth in claim 9 wherein said food product includes a food form comprising at least one of wafers, ready-to-eat cereal, granola, snack bars, snack foods, cookies, crackers, and nuts.

16. A high fiber food product as set forth in claim 15 wherein said compound coating is present in an amount of about 35% by weight and said food form is present in an amount of about 65% by weight based on the total weight of said compound coating and said food form.

17. A process of forming a high fiber compound coating comprising the steps of:
a.) providing a compound coating;
b.) mixing the compound coating with at least one dietary fiber; and
c.) winding the compound coating and dietary fiber together at a temperature of from about 55 to about 65° C. until a particle size of the mixture is less than about 35 microns.

18. A process of forming a high fiber compound coating as set forth in claim 17 wherein said grinding proceeds for about 12 hours.

19. A process of forming a high fiber compound coating as set forth in claim 17 wherein the dietary fiber includes at least one of polydextrose, short chain fructo-oligosaccharides, galacto-oligosaccharides, lignan, pectins, cereal brans, barley, psyllium, legumes, inulin, fructo-oligosaccharides, vegetable sources, fruit sources, nuts, flax seeds, and combinations thereof.

20. A process of forming a high fiber compound coating as set forth in claim 17 wherein said grinding occurs in a dual purpose centrifugal batch refiner/conche.

21. A process of forming a high fiber food product comprising the steps of:
a.) providing a compound coating;
b.) mixing the compound coating with at least one dietary fiber;
c.) grinding the compound coating and dietary fiber together at a temperature; of from about 55 to about 65° C. until a particle size of the mixture is less than about 35 microns; and
d.) applying the mixture from step c.) onto a food form.

22. A process of forming a high fiber food product as set forth in claim 21 wherein said applying the compound coating to the food form includes at least one of spraying the compound coating onto the food form; spreading the compound coating onto the food form; pumping the compound coating through depositing spindles and onto the food form; injecting the coating into the food form; and rolling the food form in the compound coating.

23. A process of forming a high fiber food product as set forth in claim 21 wherein the dietary fiber includes at least one of polydextrose, short chain fructo-oligosaccharides, galacto-oligosaccharides, lignan, pectins, cereal brans, barley, psyllium, legumes, inulin, fructo-oligosaccharides, vegetable sources, fruit sources, nuts, flax seeds, and combinations thereof.

24. A process of forming a high fiber food product as set forth in claim 21 wherein the food form includes at least one of wafers, ready-to-eat cereal, granola, snack bars, snack foods, cookies, crackers, and nuts.
